(19) United States
(12) Patent Application Publication
(10) Pub. No.: US 2010/0309219 A1
(43) Pub. Date: Dec. 9, 2010

(54) DISPLAY CALIBRATION METHODS WITH USER SETTINGS FEEBACK

(76) Inventor: Bongsun Lee, Lacrescenta, CA (US)

Correspondence Address: Robert D. Shedd, Patent Operations;THOMSON Licensing LLC, P.O. Box 5312, Princeton, NJ, 08543-5312, US

(21) Appl. No.: 12/734,615

(22) PCT Filed: Nov. 15, 2007
(86) PCT No.: PCT/US2007/023993

§ 371 Date: May 12, 2010

(51) Int. Cl. G09G 5/02; G09G 5/00

(52) U.S. Cl. 345/590; 345/581

(57) ABSTRACT

Reference image data from a reference display is utilized to manually and/or automatically calibrate a display. The reference image data is compared to measured image data from the display to derive display control settings and feedback for users and/or to automatically adjust the display. In one instance, a graphical user interface is used to relay feedback information as a user manually adjusts a display. The feedback can include suggestions for adjusting existing controls (e.g., brightness, contrast, etc.) so that a user does not have to directly interpret gamut and/or gamma information. In other instances, the feedback information is utilized to automatically adjust the display without user involvement.

### TECHNICAL FIELD

The subject matter relates generally to displays, and more particularly to systems and methods for adjusting display parameters.

### BACKGROUND

The representation of video and other images often differs from the originating source. Many factors can contribute to this, but most of the alteration is due to the characteristics of the display device itself. Thus, a reference display that is utilized to edit and create source material can display colors and intensities much differently than an end user's display. For example, most displays have settings such as brightness, contrast, hue, and backlight. The levels of those settings are either predefined by manufacturers of the displays (e.g., display modes are set as dynamic, standard, cinema, game, etc.) or manipulated by users of the displays. However, none of these methods provide the settings which will closely match the displays to the reference displays (e.g., Rec.709 displays) on which all the critical color correction and grading has been done by, for example, directors and colorists during the post production of the image contents. It is very difficult for users to find correct settings of their displays without any feedback of what has been changed as settings of the displays are changed.

### SUMMARY

Comparisons of reference image data and measured image data are leveraged to provide display parameter feedback. This allows a user's display to be manually and/or automatically corrected to a reference display. The reference display is generally utilized for editing and creating an original image content source that a user desires to view. Thus, a user can view the content as it was originally designed to be viewed, despite the user having a different model and/or type of display. In one instance, a graphical user interface is used to relay feedback information as a user manually adjusts a display. The feedback can include suggestions for adjusting existing controls (e.g., brightness, contrast, etc.) so that a user does not have to directly interpret gamut and/or gamma information and the like. In another instance, the feedback information is utilized to automatically adjust the display without user involvement.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a block diagram of a display correction system in accordance with an aspect of an embodiment.

FIG. 2 is another block diagram of a display correction system in accordance with an aspect of an embodiment.

FIG. 3 is an illustration of a display calibration system with a graphical user feedback interface in accordance with an aspect of an embodiment.

FIG. 4 is an illustration of gamut color on a graphical user feedback interface in accordance with an aspect of an embodiment.

FIG. 5 is an illustration of gamma on a graphical user feedback interface in accordance with an aspect of an embodiment.

FIG. 6 is an illustration of an example of display control settings in accordance with an aspect of an embodiment.

FIG. 7 is a flow diagram of a method of adjusting display parameters in accordance with an aspect of an embodiment.

FIG. 8 is another flow diagram of a method of adjusting display parameters in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

Typically when a creator of content such as video, for example, finalizes their creation, they pay particular attention to the “look” and “feel” of the content. Color hues, intensity levels, and other visual information play an important part in accurately portraying the art to a viewer. However, much of this information can be lost due to alteration of this information by a viewing device such as a display or monitor. The techniques described herein allow a display device to be manually and/or automatically corrected. Suggestions or feedback can also be supplied to a user to allow for adjustments to the control settings of a display without a user being knowledgeable about how the adjustments directly affect gamma or gamut and the like.

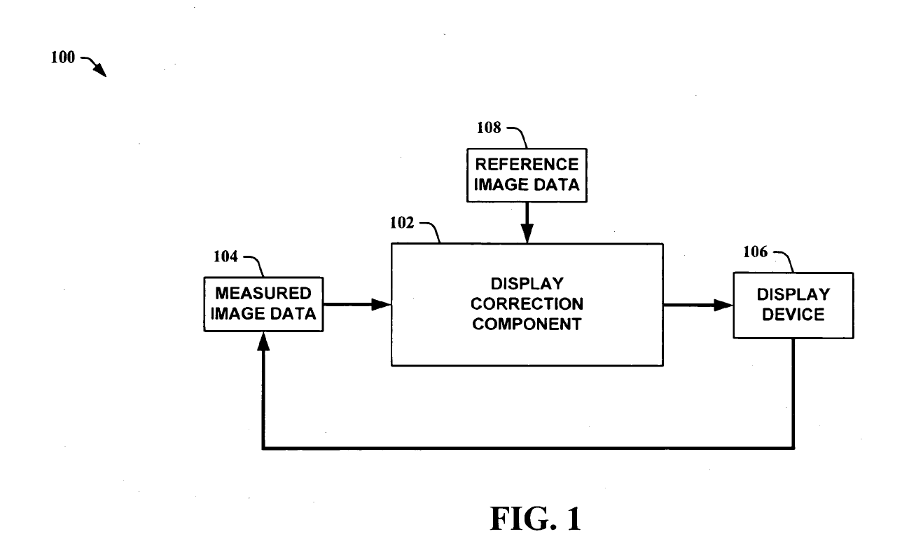

FIG. 1 shows a block diagram of a display correction system 100 that utilizes a display correction component 102 to determine display setting corrections from measured image data 104 and reference image data 108 for display device 106. The display correction system 100 can be utilized with any type of display device such as for example, computer monitors, televisions, film screens, and/or photo display devices and the like. The reference image data 108 can include data such as, for example, gamma and gamut information from a reference display that can be utilized, for example, for post production of films and other images and the like. The measured image data 104 is data that is typically directly measured from a display device such as an end user's display and the like. For example, image data can be obtained by measuring areas or “patches” on a display using a specialized device called a spectroradiometer which measures the spectral power distributions of illuminants. Thus, for example, gamma characteristics can be obtained via a series of patches that are measured directly from a display. After the measurement, a gamma curve can be drawn in a plot, “luminance vs. digital value.” This gamma can be used to compensate a mismatch with a reference gamma.

In this instance, the display correction component 102 can provide the determined display setting corrections to manually and/or automatically adjust the display device 106. Thus, a user is not required to be in a feedback loop between the display device 106 and the display correction component 102 in order to calibrate the display device 106 with regard to reference image data 108. Some displays allow control of the display settings via external means, such as via a display cable and/or wireless connections and the like.

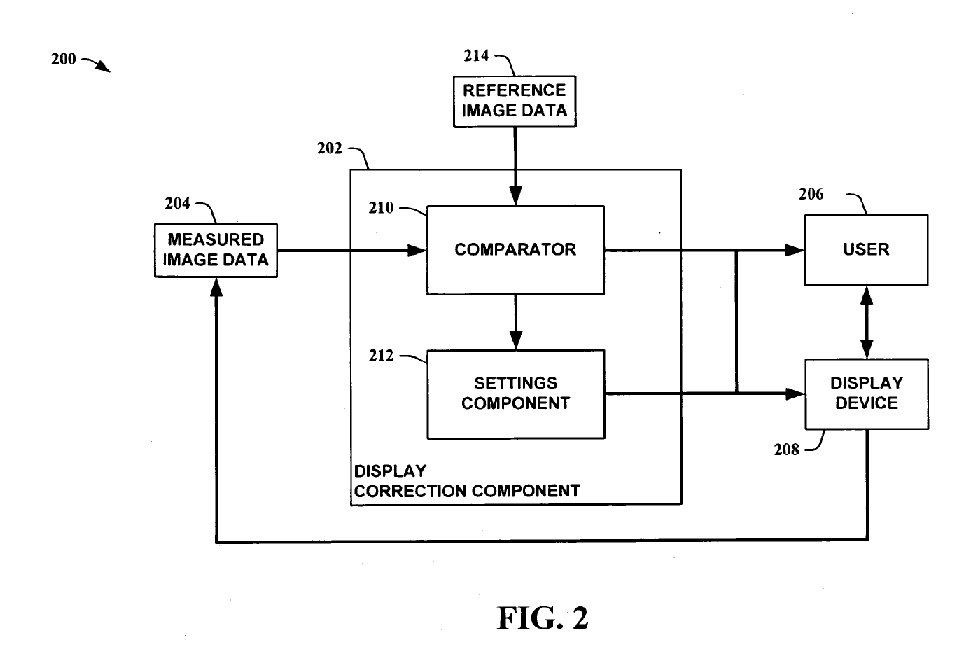

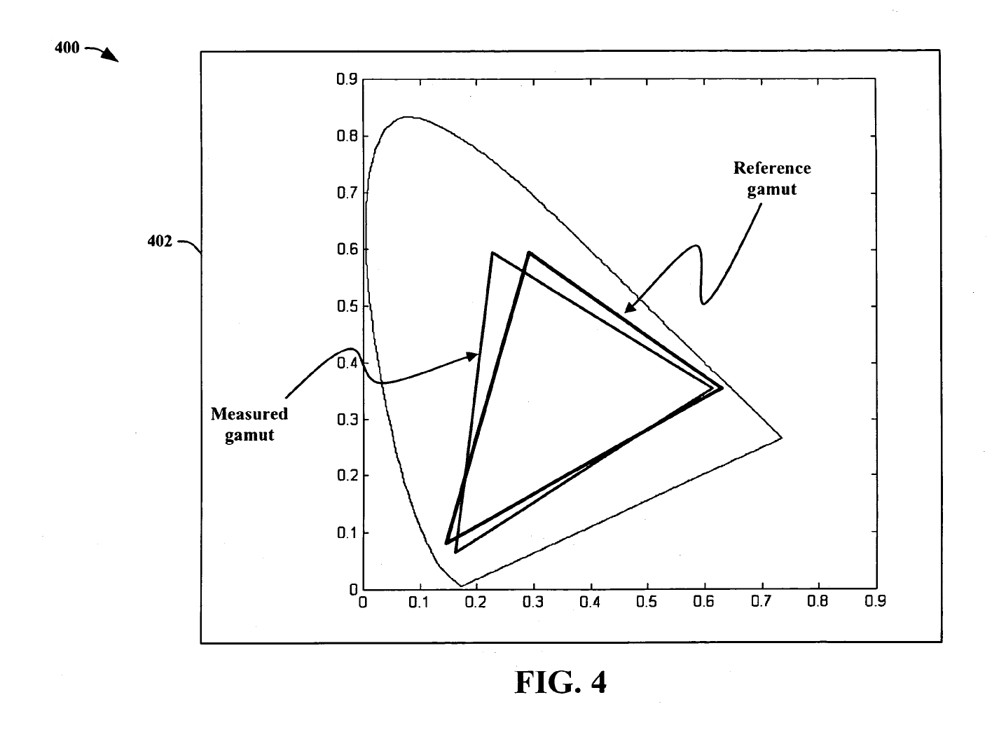

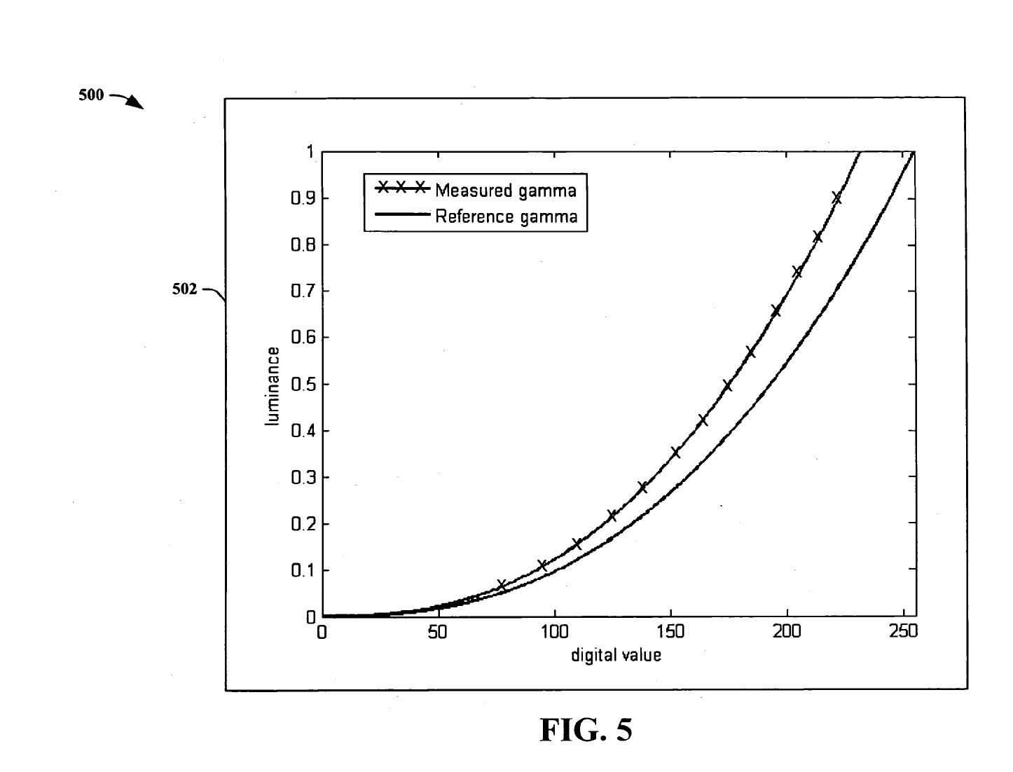

In FIG. 2, a display correction system 200 employs a display correction component 202 that receives measured image data 204 and reference image data 214 and interfaces with user 206 and/or display device 208. The display correction device 202 utilizes a comparator 210 to process the measured image data 204 and compare it to the reference image data 214. The comparator 210 can determine to what degree the measured image data 204 and the reference image data 214 disagree. In one instance, when a ratio of the compared data is less than a value of 1.0, the data can be construed to be substantially the same from a visual perspective. This type of threshold can be used to indicated when a display is correctly calibrated to the reference image data 214. The comparator 210 can also generate graphical comparisons of the data and present it to a user 206. Examples of graphical user interfaces are provided infra (see e.g., FIGS. 4 and 5).

The display correction component 202 can also utilize a settings component 212 that uses the compared data from the comparator 210 to determine control settings for proper display corrections. The settings component 212, for example, can interpret the compared data and derive setting corrections for brightness, contrast, hue, and/or backlight and the like. The derived setting corrections help in correctly calibrating the display device 208 to the reference image data 214. The suggested control settings are especially useful for inexperienced users because they provide feedback in an easily understood form. The user can directly apply the suggestions to the control settings of their display without having to interpret complicated gamut and/or gamma charts and the like. Thus, in one instance, the settings component 212 can provide feedback to the user 206 who then can adjust the display device 208. In another instance, the settings component 212 can directly interact with the display device 208 to automatically adjust its control settings and/or gamut/gamma plots and the like.

Most consumer level displays (e.g., LCD, LCoS, Plasma, DLP, CRT) show videos/pictures with different gamma and gamut color from reference displays (e.g., High quality CRTs used in color correction/grading in post production facility). Manufacturers are making efforts to enhance image qualities in terms of colors, contrast, and gammas and often claim that their displays show wider gamut colors, higher contrast ratios, etc. However, those colors, contrast, gammas are quite different from those seen in reference displays which are used to create contents in post production. As a result, a director or colorist's intent is not faithfully reproduced in those consumer level displays.

The systems and methods provided herein can provide a feedback system in order to help a user find a correct setting of their display so that it is calibrated to a reference display as close as possible for more faithful reproduction of reference colors, gamma, and contrast. In one instance, feedback can be given in the form of a graphical user interface (GUI) on a computer screen. Instances provided herein can provide a means to help to find more precise settings of displays (brightness, contrast, hue, backlight, etc.) with real-time feedbacks of measurements of current settings. This can be accomplished in the form of a GUI on a computer for users to easily understand the difference of their displays from the reference displays and keep manipulating those settings until they see the smallest difference. Similarly, the feedback can be used to automatically manipulate the settings of a display without user interaction

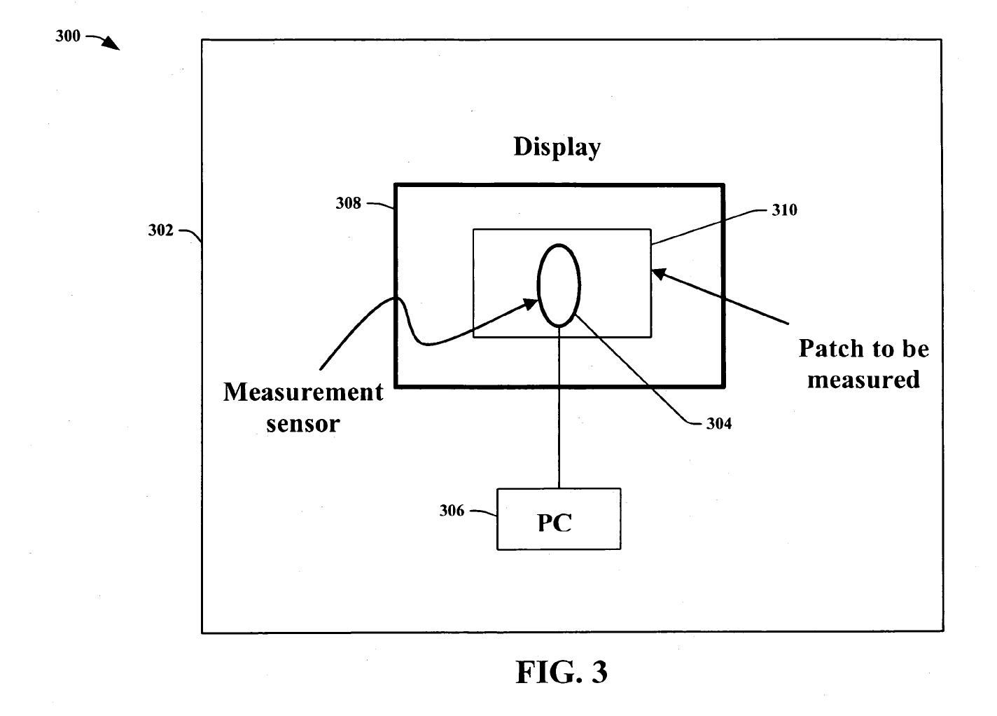

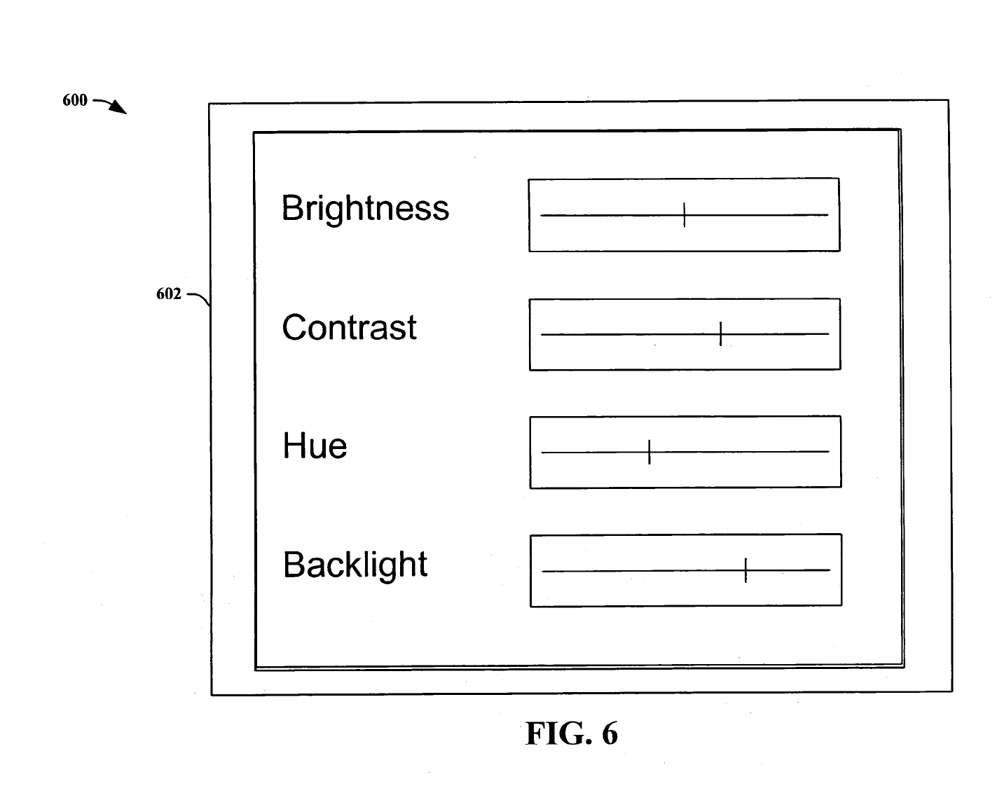

FIG. 3 shows an example 300 of a feedback system 302 comprising a PC (personal computer) 306, display 308, and a measurement sensor (e.g., spectroradiometer) 304 that measures a patch 310. The measurement sensor 304 is connected with the PC 306 via a standard communication channel (e.g., USB or RS-232C). The software running on the PC 306 can have several graphical panels. Two examples are 402, 502 as shown in FIG. 4 and FIG. 5, respectively. FIG. 4 shows an example 400 of the difference between measured gamut colors and reference gamut colors. FIG. 5 shows an example 500 of gamma from measured and from reference image data. The measurement can be done with a measurement sensor attached to a display. The sensor can measure selected color patches on a display screen. FIG. 6 shows an example 600 of control settings 602 of a display to be measured (e.g., brightness, contrast, hue, backlight). These settings, typically initially set by manufacturers of displays, can be controlled by users on the display screen, and will affect the gamut, contrast, and gamma of the display.

Once the calibration procedure starts, users can see the control settings on their display screen. If they initiate the measurement on the PC 306, a number of patches 310 can be shown on the display 308 and the measurement sensor 304 can measure each patch. A display correction system provided herein, for example, can reside on a PC and can calculate gamut color, contrast, and gamma from the measurement and show them with the reference data graphically on a display screen (see e.g., FIGS. 4 and 5). The users can then see the difference between the measured and the reference image data and can appropriately adjust the settings on the display screen, initiating the next measurement.

The new measured data can be fed back to the display correction system, and calculated gamma, gamut, and contrast can then be shown on the display screen for users to decide whether they should repeat the procedure or stop when the proper settings are found for the display. During this procedure, to give an idea to users which settings they should control, the display correction system can suggest user recommended settings for adjustment. For example, if the display correction system sees a large difference in the gamut color, but a small difference in the gamma, it can ask users to adjust hue setting only. In the opposite case (e.g., large difference in the gamma, but small difference in the gamut color), it can ask users to adjust brightness and contrast settings.

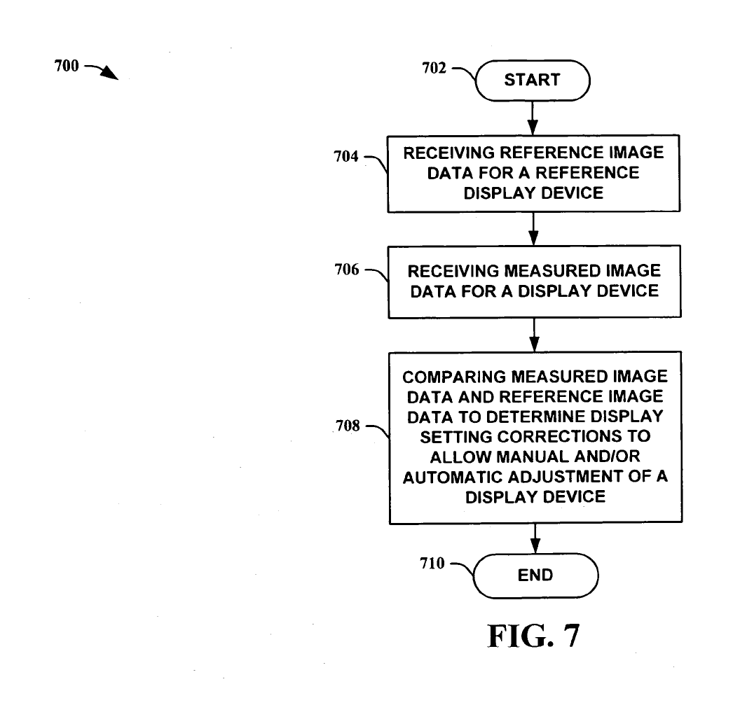

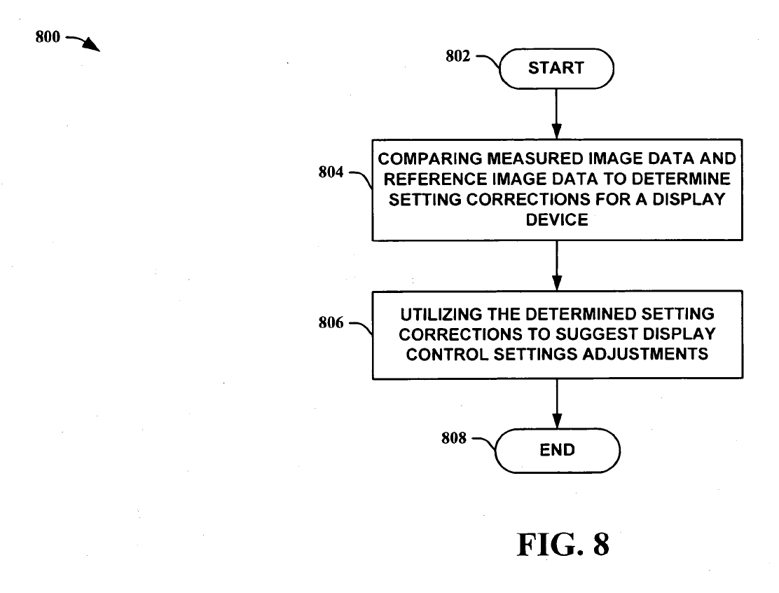

In view of the exemplary systems shown and described above, methodologies that can be implemented in accordance with the embodiments will be better appreciated with reference to the flow charts of FIGS. 7 and 8. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

In FIG. 7, a flow diagram of a method 700 of adjusting display parameters in accordance with an aspect of an embodiment is shown. The method 700 starts 702 by receiving reference image data for a reference display device 704. The reference image data is typically derived from reference displays utilized, for example, in post-production work and other content editing and/or creation work and the like. These reference displays generally duplicate the colorist's and/or director's true intent for the content being viewed. In most cases, end users do not accurately view this information because their display devices are not of similar quality and/or sophistication as the reference displays. The end user's display can also be of a different type such as, for example, an LCD display device compared to a reference CRT display device. These differences typically impact the way the content is viewed.

Measured image data is then received for a display device 706. The measured data is typically obtained from the end user's display using a sensor mounted to the display to accurately read color and intensity information. For example, various color patches can be displayed and read to obtain the measured image data. Measured image data and reference image data are then compared to determine display setting corrections to allow manual and/or automatic adjustment of a display device 708, ending the flow 710. The display setting corrections help to compensate for the differences between the data sets. This information can be relayed to a user as feedback so that the user can make adjustments manually on a display device and/or the information can be used to directly control the display device to automatically adjust its control settings.

Looking at FIG. 8, another flow diagram of a method 800 of adjusting display parameters in accordance with an aspect of an embodiment is illustrated. The method 800 starts 802 by comparing measured image data and reference image data to determine setting corrections for a display device 804. As discussed above, the reference image data can be obtained from, for example, post production displays used to prepare versions of content and the like. The measured image data is typically measured in real-time from a display that needs to be calibrated based on the reference image data. The determined setting corrections are then utilized to suggest display control settings adjustments 806, ending the flow 808.

Oftentimes, the end results of comparing reference and measured image data are graphical representations of gamut and/or gamma differences (e.g., see FIGS. 4 and 5). Inexperienced end users may not be able to correctly interpret which controls for their displays need to be adjusted to bring the graphical representations in line with each other. Thus, suggestions or feedback are derived from the determined corrections for individual display controls such as, for example, hue, brightness, contrast, and/or backlight and the like (see e.g., FIG. 6). This allows a user to calibrate their display without having to interpret complicated graphs. The user can just follow the suggestions and repeat the process until the feedback indicates the display is properly calibrated (e.g., using a threshold ratio value <1.0, etc.) and/or the user is satisfied visually with the calibration process.

In one instance, a data packet, transmitted between two or more devices that facilitates display adjustment is comprised of, at least in part, information relating to a display parameter adjustment system that utilizes, at least in part, image control setting feedback derived from comparing measured image data from a first display and image data from a reference display.

It is to be appreciated that the systems and/or methods of the embodiments can be utilized in gamma correction facilitating computer components and non-computer related components alike. Further, those skilled in the art will recognize that the systems and/or methods of the embodiments are employable in a vast array of electronic related technologies, including, but not limited to, computers, video playback devices, set top boxes, displays and/or handheld electronic devices, and the like.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a comparator that determines differences in image data representative of a first display and image data measured from a second display; and
a settings component that determines image control settings for the second display based on the compared data.

2. The system of claim 1, wherein the first display image data comprising at least gamut and gamma data.

3. The system of claim 1, wherein the image control settings comprising at least one of brightness, contrast, hue and backlight.

4. The system of claim 1, wherein the settings component automatically adjusts the image control settings for the second display.

5. The system of claim 4, wherein the settings component adjusts the second display to achieve a color difference value of less than 1.0.

6. The system of claim 1, wherein the settings component relays image control setting feedback based on the compared data to a user.

7. A method, comprising:
comparing image data representative of a first display and image data measured from a second display; and
determining image control settings for the second display based on the compared data.

8. The method of claim 7 further comprising:
utilizing first display image data comprising at least gamut and gamma data.

9. The method of claim 7 further comprising:
determining image control settings for at least one of brightness, contrast, hue and backlight.

10. The method of claim 7 further comprising:
automatically adjusting the image control settings for the second display utilizing the measured display data.

11. The method of claim 7 further comprising:
relaying image control setting suggestions based on the compared data to a user.

12. The method of claim 7 further comprising:
utilizing the determined image control settings to adjust the second display to achieve a color difference value of less than 1.0.

13. A system, comprising:
means for comparing image data representative of a first display and image data measured from a second display; and
means for determining image control settings for the second display based on the compared data.

14. The system of claim 13 further comprising:
means for automatically adjusting the second display based on the compared data.

15. The system of claim 13 further comprising:
means for suggesting image control setting changes to a user based on the compared data.

16. A data packet, transmitted between two or more devices, that facilitates display adjustment, the data packet comprising, at least in part, information relating to a display parameter adjustment system that utilizes, at least in part, image control setting feedback derived from comparing measured image data from a first display and image data from a reference display.

17. A computer readable medium having stored thereon computer executable components of the system of claim 1.

18. A device employing the method of claim 7 comprising at least one selected from the group consisting of a computer, a video playback device, a set top boxes, a display and/or a handheld electronic device.

19. A device employing the system of claim 1 comprising at least one selected from the group consisting of a computer, a video playback device, a set top boxes, a display and/or a handheld electronic device.
